(19) United States
(12) Patent Application Publication
(10) Pub. No.: US 2025/0182535 A1
(43) Pub. Date: Jun. 5, 2025

(54) APPARATUS AND METHOD FOR CONTROLLING A VEHICLE

(71) Applicants: HYUNDAI MOTOR COMPANY, Seoul (KR); KIA CORPORATION, Seoul (KR)

(72) Inventor: Ho Jin Jung, Hwaseong-si (KR)

(73) Assignees: HYUNDAI MOTOR COMPANY, Seoul (KR); KIA CORPORATION, Seoul (KR)

(21) Appl. No.: 18/952,608

(22) Filed: Nov. 19, 2024

(30) Foreign Application Priority Data
Nov. 30, 2023 (KR) 10-2023-0171459

(51) Int. Cl. G07C 5/00; H04L 9/40

(52) U.S. Cl. CPC G07C 5/008; H04L 63/126

(57) ABSTRACT

A vehicle control apparatus includes a communication device, a memory, and a control device. The vehicle control apparatus may receive, via the communication device, a request signal regarding diagnostic information of a host vehicle from at least one external device. The vehicle control apparatus may determine whether transmission of the diagnostic information is acceptable, based on a comparison result between the request signal, identification information of the at least one external device, and the mapping table. The vehicle control apparatus may transmit the diagnostic information to the at least one external device in response to determining that transmission of the diagnostic information is acceptable.

### CROSS-REFERENCE TO RELATED APPLICATION

This application claims the benefit of and priority to Korean Patent Application No. 10-2023-0171459, filed in the Korean Intellectual Property Office on Nov. 30, 2023, the entire contents of which are hereby incorporated herein by reference.

### TECHNICAL FIELD

The present disclosure relates to a vehicle control apparatus and a method thereof, and more specifically, relates to a technology for selectively transmitting and receiving data between a plurality of different devices.

### BACKGROUND

As vehicle technology gradually develops, the type and number of electronic devices implemented to control a vehicle are increasing. For example, the number of electronic devices (or controllers) installed in the vehicle is increasing as the vehicle's electronic control technology becomes advanced.

For example, at least one communication device (e.g., OBD-II) configured to transmit diagnostic information for diagnosing the performance or failure of the vehicle to an external device may be included in the vehicle. Moreover, at least one controller configured to independently diagnose the vehicle's performance or failure may be included in the vehicle.

As communication technology develops and the number and type of controllers are expanded, various devices (e.g., a telematics diagnostic device, an OTA controller, an external charging device, an external diagnostic device, and the like) may be implemented in off/on board form for vehicle diagnosis to communicate with a vehicle control apparatus. In addition, a plurality of control apparatuses may be included in the vehicle. In addition to a real-time communication technology, a technology for transmitting diagnostic information corresponding to a request signal in response to receiving the request signal may be applied.

A vehicle control apparatus may store pieces of information (e.g., vehicle identification number (VIN), sensor data, SW version, and the like) about the vehicle. However, due to limitations in the memory capacity of the vehicle control apparatus, a plurality of controllers may be implemented to store different pieces of information in different parts. In this case, the plurality of controllers need to receive specific data from other controllers as needed. Security-related issues may arise during a process of transmitting and receiving data. Furthermore, if encrypted communication is performed to prevent security issues, additional protocols are required, which may increase costs.

### SUMMARY

The present disclosure was made to solve the above-mentioned problems occurring in the prior art while advantages achieved by the prior art are maintained intact.

Aspects of the present disclosure provide a vehicle control apparatus and method that may selectively transmit specific information (e.g., diagnostic information for determining the performance of a host vehicle) to an external device based on a comparison result between a request signal, identification information of the external device and a pre-stored mapping table, when receiving the request signal for specific information from external devices (e.g., at least one controller in a vehicle, an external diagnostic device, a telematics diagnostic device, and a charging device).

Other aspects of the present disclosure provide a vehicle control apparatus and method that may store a mapping table including whether to allow full client read for each of pieces of data, and an allowed source address capable of transmitting diagnostic information if the full client read is not allowed.

Other aspects of the present disclosure provide a vehicle control apparatus and method that may determine, based on comparing DID included in the request signal with the mapping table, whether diagnostic information is information capable of allowing full client read. If diagnostic information is information capable of allowing full client read, the vehicle control apparatus may directly transmit diagnostic information to an external device. If diagnostic information is information incapable of allowing full client read, the vehicle control apparatus may determine, based on at least part of information included in the request signal, whether to transmit the diagnostic information based on identification information of the external device.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control apparatus is provided. The vehicle control apparatus includes a communication device, a memory that stores instructions and a mapping table regarding a source address, and a control device operatively connected to the communication device and the memory. When executed by the control device, the instructions cause the vehicle control apparatus to receive, based on the communication device, a request signal regarding diagnostic information of a host vehicle from at least one external device, to determine whether to allow transmission of the diagnostic information, based on a comparison result between the request signal, identification information of the at least one external device, and the mapping table, and to transmit the diagnostic information to the at least one external device when the transmission is determined to be acceptable.

According to an embodiment, the mapping table may include data identifier (DID) corresponding to pieces of data including the diagnostic information, whether to allow a full client read for each of the pieces of data, and an allowed source address capable of transmitting the diagnostic information when it is impossible to allow the full client read.

According to an embodiment, when executed by the control device, the instructions may cause the vehicle control apparatus to determine, based on comparing DID included in the request signal with the mapping table, whether the diagnostic information is information capable of allowing a full client read, and to determine that the transmission is acceptable, and transmit the diagnostic information to the at least one external device, if the diagnostic information is the information capable of allowing the full client read.

According to an embodiment, when executed by the control device, the instructions may cause the vehicle control apparatus to determine, based on comparing DID included in the request signal with the mapping table, whether the diagnostic information is information capable of allowing a full client read, and to identify, based on at least part of pieces of information included in the request signal, the identification information of the at least one external device when the diagnostic information is information incapable of allowing the full client read.

According to an embodiment, when executed by the control device, the instructions may cause the vehicle control apparatus to determine, based on comparing DID included in the request signal with the mapping table, whether the diagnostic information is information capable of allowing a full client read, to determine, based on the mapping table, whether the identification information of the at least one external device is included in an allowed source address, when the diagnostic information is information incapable of allowing the full client read, and to determine that the transmission is acceptable, and transmit the diagnostic information to the at least one external device, when the identification information is included in the allowed source address.

According to an embodiment, when executed by the control device, the instructions may cause the vehicle control apparatus to determine, based on comparing DID included in the request signal with the mapping table, whether the diagnostic information is information capable of allowing a full client read, to determine, based on the mapping table, whether the identification information of the at least one external device is included in an allowed source address, when the diagnostic information is information incapable of allowing the full client read, and to determine that it is impossible to allow the transmission, and not transmit the diagnostic information, when the identification information is not included in the allowed source address.

According to an embodiment, when executed by the control device, the instructions may cause the vehicle control apparatus to determine that it is impossible to allow the transmission, and transmit a negative response code (NRC) to the at least one external device, when the identification information is not included in the allowed source address.

According to an embodiment, the at least one external device may include at least one of a remote diagnostic device, a charging device, at least one internal controller included in the host vehicle, an external diagnostic device electrically connected to the vehicle control apparatus based on an on-board diagnostics (OBD) included in the communication device, or any combination thereof.

According to another aspect of the present disclosure, a vehicle control method is provided. The vehicle control method includes receiving, based on a communication device, a request signal regarding diagnostic information of a host vehicle from at least one external device by a control device. The vehicle control method also includes determining, by the control device, whether to allow transmission of the diagnostic information, based on a comparison result between the request signal, identification information of the at least one external device, and a mapping table stored in a memory. The vehicle control method additionally includes transmitting, by the control device, the diagnostic information to the at least one external device when the transmission is determined to be acceptable.

According to an embodiment, the mapping table may include a DID corresponding to pieces of data including the diagnostic information, whether to allow a full client read for each of the pieces of data, and an allowed source address capable of transmitting the diagnostic information when it is impossible to allow the full client read.

According to an embodiment, the vehicle control method may further include determining, based on comparing DID included in the request signal with the mapping table, whether the diagnostic information is information capable of allowing a full client read, by the control device, and determining, by the control device, that the transmission is acceptable, and transmitting the diagnostic information to the at least one external device, when the diagnostic information is the information capable of allowing the full client read.

According to an embodiment, the vehicle control method may further include determining, based on comparing DID included in the request signal with the mapping table, whether the diagnostic information is information capable of allowing a full client read, by the control device, and identifying, based on at least part of pieces of information included in the request signal, the identification information of the at least one external device by the control device when the diagnostic information is information incapable of allowing the full client read.

According to an embodiment, the vehicle control method may further include determining, based on comparing DID included in the request signal with the mapping table, whether the diagnostic information is information capable of allowing a full client read, by the control device, determining, based on the mapping table, whether the identification information of the at least one external device is included in an allowed source address, by the control device when the diagnostic information is information incapable of allowing the full client read, and determining, by the control device, that the transmission is acceptable, and transmitting the diagnostic information to the at least one external device, when the identification information is included in the allowed source address.

According to an embodiment, the vehicle control method may further include determining, based on comparing DID included in the request signal with the mapping table, whether the diagnostic information is information capable of allowing a full client read, by the control device, determining, based on the mapping table, whether the identification information of the at least one external device is included in an allowed source address, by the control device when the diagnostic information is information incapable of allowing the full client read, and determining, by the control device, that it is impossible to allow the transmission, and not transmitting the diagnostic information, when the identification information is not included in the allowed source address.

According to an embodiment, the vehicle control method may further include determining, by the control device, that it is impossible to allow the transmission, and transmitting an NRC to the at least one external device, when the identification information is not included in the allowed source address.

According to another aspect of the present disclosure, a computer-readable recording medium including a program for executing a vehicle control method is provided. The vehicle control method includes receiving, based on a communication device, a request signal regarding diagnostic information of a host vehicle from at least one external device by a control device. The vehicle control method also includes determining, by the control device, whether to allow transmission of the diagnostic information, based on a comparison result between the request signal, identification information of the at least one external device, and a mapping table stored in a memory. The vehicle control method additionally includes transmitting, by the control device, the diagnostic information to the at least one external device when the transmission is determined to be acceptable.

According to an embodiment, the mapping table may include a DID corresponding to pieces of data including the diagnostic information, whether to allow a full client read for each of the pieces of data, and an allowed source address capable of transmitting the diagnostic information when it is impossible to allow the full client read.

According to an embodiment, the vehicle control method may further include determining, based on comparing DID included in the request signal with the mapping table, whether the diagnostic information is information capable of allowing a full client read, by the control device, and determining, by the control device, that the transmission is acceptable, and transmitting the diagnostic information to the at least one external device, when the diagnostic information is the information capable of allowing the full client read.

According to an embodiment, the vehicle control method may further include determining, based on comparing DID included in the request signal with the mapping table, whether the diagnostic information is information capable of allowing a full client read, by the control device, and identifying, based on at least part of pieces of information included in the request signal, the identification information of the at least one external device by the control device when the diagnostic information is information incapable of allowing the full client read.

According to an embodiment, the vehicle control method may further include determining, based on comparing DID included in the request signal with the mapping table, whether the diagnostic information is information capable of allowing a full client read, by the control device, determining, based on the mapping table, whether the identification information of the at least one external device is included in an allowed source address, by the control diagnostic information is information incapable of allowing the full client read, and determining, by the control device, that the transmission is acceptable, and transmitting the diagnostic information to the at least one external device, when the identification information is included in the allowed source address.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram showing components of a vehicle control system, according to an embodiment of the present disclosure;

FIG. 2 is a table illustrating pieces of information included in a request signal, according to an embodiment of the present disclosure;

FIG. 3 is a table illustrating pieces of information included in a mapping table, according to an embodiment of the present disclosure;

FIG. 4 is a flowchart of a vehicle control method, according to an embodiment of the present disclosure;

FIG. 5 is a flowchart of a vehicle control method, according to an embodiment of the present disclosure; and

FIG. 6 shows a computing system related to a vehicle control apparatus or vehicle control method, according to an embodiment of the present disclosure.

With regard to description of drawings, the same or similar components are designated by the same or similar reference numerals.

### DETAILED DESCRIPTION

Hereinafter, embodiments of the present disclosure are described in detail with reference to the accompanying drawings. In adding reference numerals to components of each drawing, it should be noted that the same components are designated by the same reference numerals even when the components are illustrated in different drawings. Furthermore, in describing the embodiments of the present disclosure, detailed descriptions associated with well-known functions or configurations have been omitted when it was determined that the descriptions may unnecessarily obscure the gist of the present disclosure.

In describing elements of embodiments of the present disclosure, the terms first, second, A, B, (a), (b), and the like may be used herein. These terms are only used to distinguish one element from another element. These terms do not limit the corresponding elements irrespective of the nature, order, or priority of the corresponding elements. Furthermore, unless otherwise defined, all terms including technical and scientific terms used herein should be interpreted as is customary in the art to which the present disclosure pertains. It should be understood that terms used herein should be interpreted as including a meaning that is consistent with their meaning in the context of the present disclosure and the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

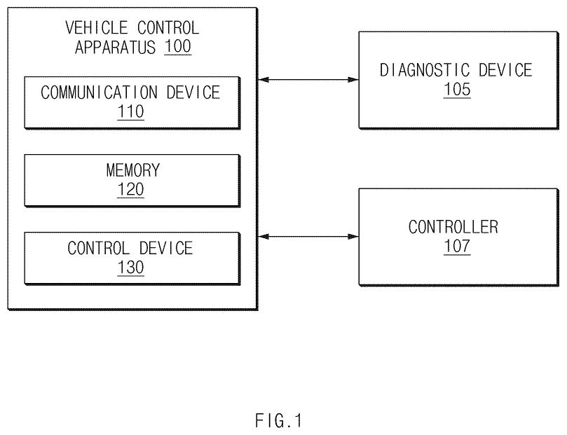

Hereinafter, various embodiments of the present disclosure are described in detail with reference to FIGS. 1-6.

FIG. 1 is a block diagram showing components of a vehicle control system, according to an embodiment of the present disclosure.

According to one embodiment, a vehicle control system may include at least one device. For example, the vehicle control system may include at least one of a vehicle control apparatus 100, a diagnostic device 105, a controller 107, or any combination thereof.

In an example, the diagnostic device 105 may be provided inside a host vehicle and may include at least one internal diagnostic device that obtains and stores diagnostic information about the performance of the host vehicle.

In another example, the diagnostic device 105 may be provided outside the host vehicle and may include at least one external diagnostic device that receives and stores diagnostic information about the performance of the host vehicle from a communication device 110. For example, the external diagnostic device may be electrically connected to the vehicle control apparatus 100 based on on-board diagnostics (OBD) included in the communication device 110.

For example, the diagnostic device 105 may include a telematics diagnostic device (or a remote diagnostic device). The telematics diagnostic device may receive diagnostic information about the t performance of the host through the communication device 110 and may perform a diagnostic function on the host vehicle.

As another example, the diagnostic device 105 may include a charging device. The charging device may receive diagnostic information about the performance of the host vehicle from the host vehicle (or from the vehicle control apparatus 100) while the host vehicle is charged and may perform a diagnostic function on the host vehicle.

The controller 107 may include a separate controller (or a control apparatus that is included inside the host vehicle and that is distinguished from the vehicle control apparatus 100. The separate controller may perform the diagnostic function on the host vehicle based on the diagnostic information received from the vehicle control apparatus 100.

According to an embodiment, the vehicle control apparatus 100 may include the communication device 110, a memory 120, and a control device 130. The configuration of the vehicle control apparatus 100 shown in FIG. 1 is an example, and embodiments of the present disclosure are not limited thereto. For example, the vehicle control apparatus 100 may further include components not shown in FIG. 1 (e.g., at least one of a sensor device, an interface device, a display device, a notification device, or any combination thereof).

According to an embodiment, the communication device 110 may establish a communication channel (e.g., a wireless communication channel) between the vehicle control apparatus 100 and an external device (e.g., the diagnostic device 105 and/or the controller 107) and may support communication through the established communication channel. In an example, the communication device 110 may include one or more communication processors that are operated independently of the control device 130 (e.g., an application processor) and support direct (or wired) communication or wireless communication.

The communication device 110 may include a wireless communication module (e.g., a cellular communication module, a short-range wireless communication module, or a global navigation satellite system (GNSS) communication module) or a wired communication module (e.g., a local area network (LAN) communication module or a power line communication module). The corresponding communication module among these communication modules may communicate with an external device through a first network (e.g., a short-range communication network such as Bluetooth, WiFi, direct or infrared data association (IrDA)) or a second network (e.g., long-range wireless communication network such as a legacy cellular network, 5G networks, next-generation communication networks, Internet, or computer networks (e.g., LAN or WAN)) included in a network. The above-described types of communication modules may be integrated in one component (e.g., a single chip) or may be implemented with a plurality of components (e.g., a plurality of chips) which are independent of each other. Also, the communication device 110 and the control device 130 may be implemented as a single chip.

The communication device 110 may transmit or receive various data based on communication with external devices.

The communication device 110 may include at least one device (e.g., OBD and/or OBD-II) according to a standard for transmitting and receiving diagnostic information about the performance of the diagnostic device 105 and/or the controller 107 and the host vehicle. The communication device 110 may be electrically connected to external devices (e.g., an external diagnostic device) based on at least one device.

According to an embodiment, the memory 120 may store instructions and/or data. For example, the memory 120 may store one or more instructions that cause the vehicle control apparatus 100 to perform various operations when executed by the control device 130.

In an example, the memory 120 and the control device 130 may be implemented as one chipset. The control device 130 may include at least one of a communication processor or a modem.

The memory 120 may store various pieces of information related to the vehicle control apparatus 100. For example, the memory 120 may store information about the operation history of the control device 130. As another example, the memory 120 may store information related to states and/or operations of components (e.g., at least one of an engine control unit (ECU), a sensor device, a driving device, the memory 120, an input device, a notification device, or any combination thereof) of the host vehicle.

The memory 120 may include different types of storage devices. For example, the memory 120 may include at least one of a random-access memory (RAM), an embedded multi-media card (eMMC), or any combination thereof.

The RAM may temporarily (or transiently) store data (e.g., sensor data) regarding the operation of the vehicle control apparatus 100 and/or the host vehicle to be controlled by the vehicle control apparatus 100. The RAM may include at least one buffer.

The eMMC may include an embedded multimedia card. For example, the eMMC may store data for a longer period of time than the RAM. For example, the eMMC may be implemented as a separate memory chip separate from the RAM.

In an example, the memory 120 may store a mapping table. For example, the mapping table may store pieces of information about source address (SA).

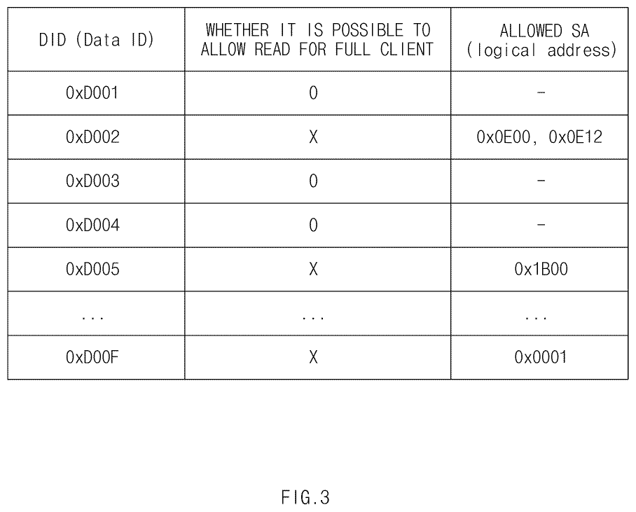

The mapping table may include data identifier (DID) corresponding to pieces of data including diagnostic information, whether to allow a full client read for each of pieces of data, and an allowed source address capable of transmitting diagnostic information if the full client read is not allowed. An example of the mapping table, according to an embodiment, is described in more detail below with reference to FIG. 3.

According to an embodiment, the control device 130 may be operatively connected to the communication device 110 and/or the memory 120. For example, the control device 130 may control the operation of the communication device 110 and/or the memory 120.

In an embodiment, the control device 130 may receive, based on the communication device 110, a request signal regarding diagnostic information of the host vehicle from at least one external device (e.g., the diagnostic device 105 and/or the controller 107).

The request signal may include identification information of the at least one external device transmitting the request signal. The control device 130 may identify the identification information of the at least one external device based on the request signal.

The control device 130 may determine whether to allow the transmission of the diagnostic information (i.e., determine whether transmission of the diagnostic information is acceptable), based on the comparison results between the request signal, the identification information of the at least one external device, and the mapping table.

When the transmission is determined to be acceptable, the control device 130 may transmit diagnostic information to the at least one external device.

For example, the control device 130 may determine, based on comparing the DID included in the request signal with the mapping table, whether the diagnostic information is information capable of allowing a full client read. The DID may be identification information corresponding to information (e.g., diagnostic information) requested by the at least one external device. If the diagnostic information is information capable of allowing the full client read, the control device 130 may determine that the transmission is acceptable and may transmit the diagnostic information to at least one external device.

On the other hand, if the diagnostic information is information incapable of allowing the full client read, the control device 130 may identify, based on at least part of pieces of information included in the request signal, the identification information of the at least one external device.

For example, the control device 130 may determine, based on comparing the DID included in the request signal with the mapping table, whether the diagnostic information is information capable of allowing the full client read. If the diagnostic information is information incapable of allowing the full client read, the control device 130 may determine, based on the mapping table, whether the identification information of at least one external device is included in the allowed source address. If the identification information is included in the allowed source address, the control device 130 may determine that the transmission of the diagnostic information is acceptable, and may transmit the diagnostic information to the at least one external device.

On the other hand, if the identification information of the at least one external device is not included in the allowed source address, the control device 130 may determine that the transmission is unacceptable and may not transmit the diagnostic information. In this case, the control device 130 may transmit a negative response code (NRC) to the at least one external device. For example, the NRC may include notification information indicating that it is impossible to transmit the diagnostic information.

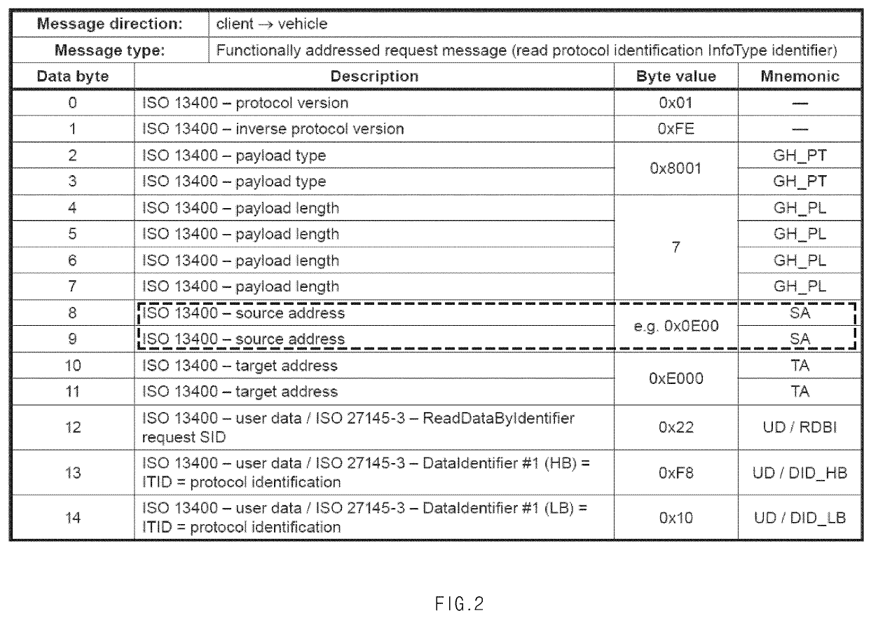

FIG. 2 is a table illustrating pieces of information included in a request signal, according to an embodiment of the present disclosure.

According to an embodiment, a vehicle control apparatus (e.g., the vehicle control apparatus 100 of FIG. 1) may receive a request signal from at least one external device (e.g., the diagnostic device 105 and/or the controller 107 of FIG. 1).

The request signal may be a signal for requesting diagnostic information about a host vehicle stored by a vehicle control apparatus. The at least one external device may request the diagnostic information required to perform a diagnostic function for the host vehicle from the vehicle control apparatus through the request signal.

The request signal may include various pieces of information. For example, the request signal may include at least one of a protocol version, an inverse protocol version, a payload type, a payload length, a source address SA, a target address TA, user data, or any combination thereof.

In an example, the request signal may include the DID of information (e.g., diagnostic information) requested by at least one external device from the vehicle control apparatus.

The vehicle control apparatus may identify a source address of the at least one external device based on the request signal.

The vehicle control apparatus may determine, based on comparing the DID included in the request signal with a mapping table, whether the diagnostic information is information capable of allowing a full client read. If the diagnostic information is information incapable of allowing the full client read, the vehicle control apparatus may identify identification information of the at least one external device based on the source address corresponding to Data byte 8 and Data byte 9 among pieces of information included in the request signal.

For example, referring to FIG. 2, the identification information of the at least one external device may be 0x0E00. However, this is an example, and embodiments of the present disclosure are not limited thereto.

FIG. 3 is a table illustrating pieces of information included in a mapping table, according to an embodiment of the present disclosure.

According to an embodiment, a vehicle control apparatus (e.g., the vehicle control apparatus 100 of FIG. 1) may store a mapping table in a memory (e.g., the memory 120 in FIG. 1).

In an example, the mapping table may include pieces of information about source addresses.

For example, the mapping table may include a DID corresponding to each of various pieces of diagnostic information stored by the vehicle control apparatus. Referring to FIG. 3, the mapping table stored by the vehicle control apparatus may store DID including 0xD001, 0xD002, 0xD003, 0xD004, 0xD005, . . . , and 0xD00F.

The mapping table may store transmission condition information corresponding to each DID.

Referring to FIG. 3, for example, diagnostic information corresponding to 0xD001 may be information allowed to be read for the full client. Accordingly, if the request signal received by the vehicle control apparatus is a signal requesting the diagnostic information corresponding to 0xD001, the vehicle control apparatus may immediately transmit the diagnostic information corresponding to 0xD001 to at least one external device regardless of the source address of the external device transmitting the request signal.

Referring still to FIG. 3, diagnostic information corresponding to 0xD002 may be information that is not allowed to be read for the full client. Accordingly, if the request signal received by the vehicle control apparatus is a signal requesting diagnostic information corresponding to 0xD002, the vehicle control apparatus may determine whether transmission is possible, based on the source address of the external device transmitting the request signal. For example, the vehicle control apparatus may identify the identification information of the external device based on the request signal, and may identify that the allowed source addresses corresponding to 0xD002 are 0x0E00 and 0x0E12 according to the mapping table. In this case, if the identification information of the external device is one of 0x0E00 and 0x0E12, the vehicle control apparatus may transmit the diagnostic information corresponding to 0xD002 to the external device. If the identification information of the external device is not 0x0E00 or 0x0E12, the vehicle control apparatus may not transmit the diagnostic information to the external device. In this case, the vehicle control apparatus may transmit a negative response code (NRC) to the external device.

Although receiving a request signal for diagnostic information corresponding to other DIDs (e.g., 0xD003, 0xD004, 0xD005, . . . , and 0xD00F) is not described in more detail herein, it is noted that the vehicle control apparatus may determine whether to transmit the diagnostic information based on substantially the same method as the above-described embodiment.

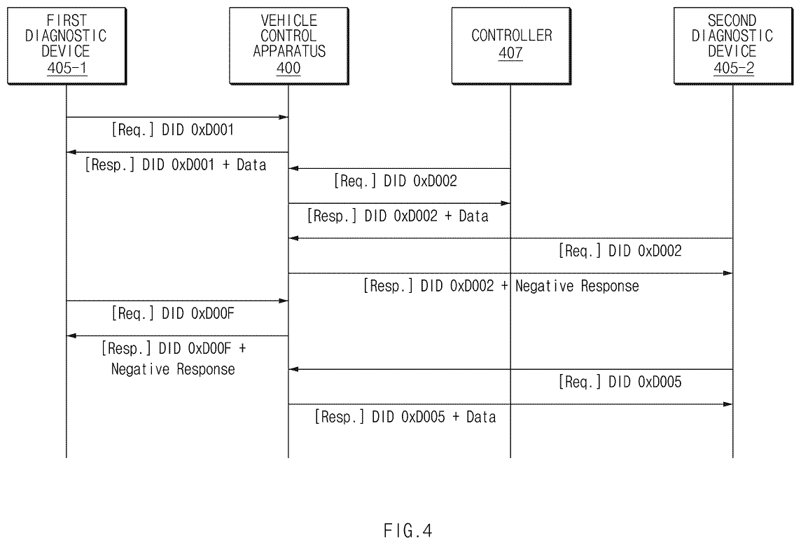

FIG. 4 is a flowchart of a vehicle control method, according to an embodiment of the present disclosure.

According to an embodiment, a vehicle control apparatus 400 (e.g., corresponding to the vehicle control apparatus 100 of FIG. 1), a first diagnostic device 405-1, a second diagnostic device 405-2 (e.g., corresponding to the diagnostic device 105 in FIG. 1), and/or a controller 407 (e.g., corresponding to the controller 107 in FIG. 1) may perform operations disclosed in FIG. 4. For example, at least some of components (e.g., the communication device 110, the memory 120, and the control device 130 in FIG. 1) included in the vehicle control apparatus 400 may be configured to perform operations performed by the vehicle control apparatus 400 in FIG. 4.

According to an embodiment, the vehicle control apparatus 400 may receive a request signal (e.g., [Req.] DID 0xD001) from the first diagnostic device 405-1. The vehicle control apparatus 400 may identify, based on comparing DID 0xD001 corresponding to the request signal with a mapping table, that diagnostic information corresponding to 0xD001 is information capable of allowing a full client read. Accordingly, the vehicle control apparatus 400 may transmit the diagnostic information (e.g., [Resp.] 0xD001+Data) corresponding to 0xD001 to the first diagnostic device 405-1.

According to an embodiment, the vehicle control apparatus 400 may receive a request signal (e.g., [Req.] DID 0xD00F) from the first diagnostic device 405-1. The vehicle control apparatus 400 may identify, based on comparing DID 0xD00F corresponding to the request signal with the mapping table, that diagnostic information corresponding to 0xD00F is information incapable of allowing the full client read. Accordingly, the vehicle control apparatus 400 may identify, based on at least part of pieces of information included in the request signal, identification information of the first diagnostic device 405-1. The vehicle control apparatus 400 may identify that the identification information (e.g., 0x0E00) of the first diagnostic device 405-1 is not included in an allowed source address of DID 0xD00F according to the mapping table. Accordingly, the vehicle control apparatus 400 may not transmit diagnostic information corresponding to 0xD00F and/or may transmit a negative response code (NRC) to the first diagnostic device 405-1.

According to an embodiment, the vehicle control apparatus 400 may receive a request signal (e.g., [Req.] DID 0xD002) from the controller 407. The vehicle control apparatus 400 may identify, based on comparing DID 0xD002 corresponding to the request signal with the mapping table, that diagnostic information corresponding to 0xD002 is information incapable of allowing the full client read. Accordingly, the vehicle control apparatus 400 may identify, based on at least part of pieces of information included in the request signal, identification information of the controller 407. The vehicle control apparatus 400 may identify that the identification information (e.g., 0x0E12) of the controller 407 is included in the allowed source address of DID 0xD002 according to the mapping table. Accordingly, the vehicle control apparatus 400 may transmit diagnostic information (e.g., [Resp.] 0xD002+Data) corresponding to 0xD002 to the controller 407.

According to an embodiment, the vehicle control apparatus 400 may receive a request signal (e.g., [Req.] DID 0xD002) from the second diagnostic device 405-2. The vehicle control apparatus 400 may identify, based on comparing DID 0xD002 corresponding to the request signal with the mapping table, that diagnostic information corresponding to 0xD002 is information incapable of allowing the full client read. Accordingly, the vehicle control apparatus 400 may identify, based on at least part of pieces of information included in the request signal, identification information of the second diagnostic device 405-2. The vehicle control apparatus 400 may identify that the identification information (e.g., 0x1B00) of the second diagnostic device 405-2 is not included in an allowed source address of DID 0xD002 according to the mapping table. Accordingly, the vehicle control apparatus 400 may transmit diagnostic information not corresponding to 0xD002 and/or may transmit a negative response code (NRC) to the second diagnostic device 405-2.

According to an embodiment, the vehicle control apparatus 400 may receive a request signal (e.g., [Req.] DID 0xD005) from the second diagnostic device 405-2. The vehicle control apparatus 400 may identify, based on comparing DID 0xD005 corresponding to the request signal with the mapping table, that diagnostic information corresponding to 0xD005 is information incapable of allowing the full client read. Accordingly, the vehicle control apparatus 400 may identify, based on at least part of pieces of information included in the request signal, identification information of the second diagnostic device 405-2. The vehicle control apparatus 400 may identify that the identification information (e.g., 0x1B00) of the second diagnostic device 405-2 is included in an allowed source address of DID 0xD005 according to the mapping table. Accordingly, the vehicle control apparatus 400 may transmit the diagnostic information (e.g., [Resp.] 0xD005 +Data) corresponding to 0xD005 to the second diagnostic device 405-2.

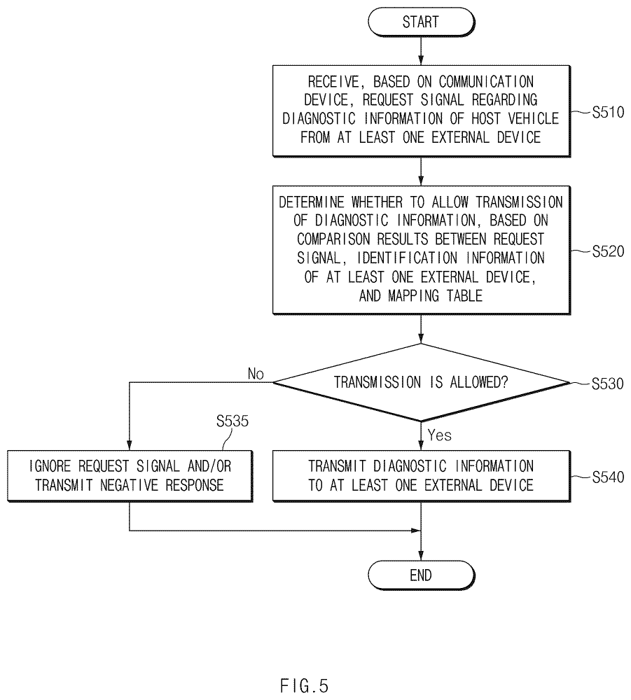

FIG. 5 is a flowchart of a vehicle control method, according to an embodiment of the present disclosure.

According to an embodiment, a vehicle control apparatus (e.g., the vehicle control apparatus 100 of FIG. 1) may perform operations described in FIG. 5. For example, at least some of components (e.g., the communication device 110, the memory 120, and the control device 130 in FIG. 1) included in the vehicle control apparatus may be configured to perform operations of FIG. 5.

In the following embodiment, operations S510-S540 may be sequentially performed, but are not always performed sequentially. For example, the order of operations may be changed and/or at least two operations may be performed in parallel. Moreover, descriptions corresponding to or identical to the above-mentioned descriptions given with reference to FIG. 5 may be briefly described or omitted to avoid redundancy.

In an operation S510, the vehicle control apparatus may receive, based on a communication device, a request signal regarding diagnostic information of a host vehicle from at least one external device.

In an operations S520 and S530, the vehicle control apparatus may determine whether to allow the transmission of the diagnostic information (i.e., determine whether transmission of the diagnostic information is acceptable), based on the comparison results between the request signal, the identification information of the at least one external device, and the mapping table.

According to an embodiment, the vehicle control apparatus may determine whether the transmission is allowed (i.e., determine whether the transmission is acceptable).

When transmission of diagnostic information is determined to be acceptable (Yes in the operation S530), the vehicle control apparatus may perform an operation S540.

On the other hand, when transmission of the diagnostic information is determined to be not acceptable (No in the operation S530), the vehicle control apparatus may perform an operation S535.

In the operation S535, the vehicle control apparatus may ignore the request signal and/or may transmit a negative response (e.g., NRC).

For example, the vehicle control apparatus may not transmit the diagnostic information. Furthermore, the vehicle control apparatus may selectively transmit a negative response to the at least one external device transmitting the request signal.

In the operation S540, the vehicle control apparatus may transmit the diagnostic information to the at least one external device.

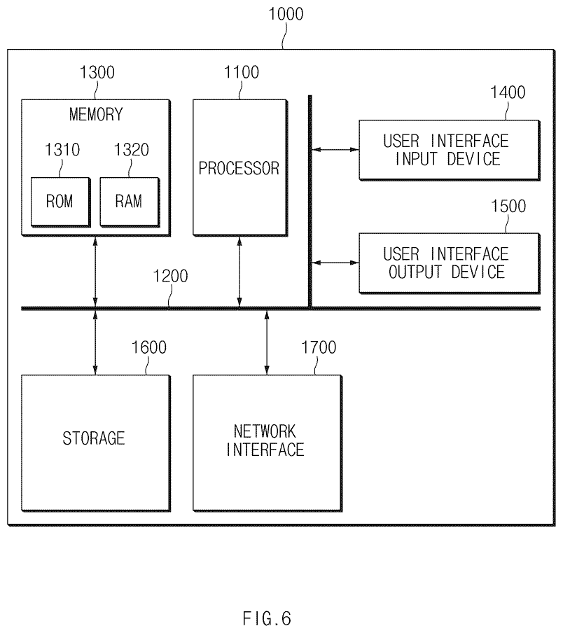

FIG. 6 shows a computing system related to a vehicle control apparatus or vehicle control method, according to an embodiment of the present disclosure.

Referring to FIG. 6, a computing system 1000 related to a vehicle control apparatus or a vehicle control method may include at least one processor 1100, a memory 1300, a user interface input device 1400, a user interface output device 1500, a storage 1600, and a network interface 1700, connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module executed by the processor 1100. The software module may reside on a storage medium (e.g., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and alterations may be made by one having ordinary skill in the art without departing from the scope of the present disclosure.

Accordingly, embodiments of the present disclosure are intended not to limit but to explain the technical idea of the present disclosure. The scope and spirit of the present disclosure is not limited by the above embodiments. The scope of protection of the present disclosure should be construed by the appended claims, and all equivalents thereof should be construed as being included within the scope of the present disclosure.

Descriptions of a vehicle control apparatus and a vehicle control apparatus method according to embodiments of the present disclosure are as follows.

Embodiments of the present disclosure provide a vehicle control apparatus and method that may selectively transmit specific information (e. g., diagnostic information for determining the performance of a host vehicle) to an external device based on a comparison result between a request signal, identification information of the external device and a pre-stored mapping table, when receiving the request signal for specific information from external devices (e.g., at least one controller inside a vehicle, an external diagnostic device, a telematics diagnostic device, and a charging device).

Embodiments of the present disclosure provide a vehicle control apparatus and method that may store a mapping table including whether to allow full client read for each of pieces of data, and an allowed source address capable of transmitting diagnostic information if the full client read is not allowed.

Embodiments of the present disclosure provide a vehicle control apparatus and method that may determine, based on comparing DID included in the request signal with the mapping table, whether diagnostic information is information capable of allowing full client read. If diagnostic information is information capable of allowing full client read, the vehicle control apparatus and method may directly transmit diagnostic information to an external device. If diagnostic information is information incapable of allowing full client read, the vehicle control apparatus and method may determine, based on at least part of information included in the request signal, whether to transmit the diagnostic information based on identification information of the external device.

Further, a variety of effects directly or indirectly understood through the present disclosure may be provided.

Hereinabove, although the present disclosure was described with reference to example embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

What is claimed is:

1. A vehicle control apparatus comprising:
a communication device;
a memory configured to store instructions and a mapping table regarding a source address; and
a control device operatively connected to the communication device and the memory,
wherein the instructions, when executed by the control device, cause the vehicle control apparatus to
receive, via the communication device, a request signal regarding diagnostic information of a host vehicle from at least one external device,
determine whether transmission of the diagnostic information is acceptable, based on a comparison result between the request signal, identification information of the at least one external device, and the mapping table, and
transmit the diagnostic information to the at least one external device when transmission of the diagnostic information is determined to be acceptable.

2. The vehicle control apparatus of claim 1, wherein the mapping table includes:
data identifier (DID) corresponding to pieces of data including the diagnostic information;
whether to allow a full client read for each of the pieces of data; and
an allowed source address capable of transmitting the diagnostic information if the full client read is not allowed.

3. The vehicle control apparatus of claim 1, wherein the instructions, when executed by the control device, cause the vehicle control apparatus to:
determine, based on comparing DID included in the request signal with the mapping table, whether the diagnostic information is information capable of allowing a full client read; and
determine that transmission of the diagnostic information is acceptable, and transmit the diagnostic information to the at least one external device, in response to determining that the diagnostic information is information capable of allowing the full client read.

4. The vehicle control apparatus of claim 1, wherein the instructions, when executed by the control device, cause the vehicle control apparatus to:
determine, based on comparing DID included in the request signal with the mapping table, whether the diagnostic information is information capable of allowing a full client read; and
identify, based on at least part of pieces of information included in the request signal, the identification information of the at least one external device in response to determining that the diagnostic information is information incapable of allowing the full client read.

5. The vehicle control apparatus of claim 1, wherein the instructions, when executed by the control device, cause the vehicle control apparatus to:
determine, based on comparing DID included in the request signal with the mapping table, whether the diagnostic information is information capable of allowing a full client read;
determine, based on the mapping table, whether the identification information of the at least one external device is included in an allowed source address, in response to determining that the diagnostic information is information incapable of allowing the full client read; and
determine that transmission of the diagnostic information is acceptable, and transmit the diagnostic information to the at least one external device, in response to determining that the identification information is included in the allowed source address.

6. The vehicle control apparatus of claim 1, wherein the instructions, when executed by the control device, cause the vehicle control apparatus to:
determine, based on comparing DID included in the request signal with the mapping table, whether the diagnostic information is information capable of allowing a full client read;
determine, based on the mapping table, whether the identification information of the at least one external device is included in an allowed source address, i response to determining that the diagnostic information is information incapable of allowing the full client read; and
determine that transmission of the diagnostic information is not acceptable, and not transmit the diagnostic information, in response to determining that the identification information is not included in the allowed source address.

7. The vehicle control apparatus of claim 6, wherein the instructions, when executed by the control device, cause the vehicle control apparatus to determine that transmission of the diagnostic information is not acceptable, and transmit a negative response code (NRC) to the at least one external device, in response to determining that the identification information is not included in the allowed source address.

8. The vehicle control apparatus of claim 1, wherein the at least one external device includes at least one of a remote diagnostic device, a charging device, at least one internal controller included in the host vehicle, an external diagnostic device electrically connected to the vehicle control apparatus based on an on-board diagnostics (OBD) included in the communication device, or any combination thereof.

9. A vehicle control method comprising:
receiving, by a control device via a communication device, a request signal regarding diagnostic information of a host vehicle from at least one external device by a control device;
determining, by the control device, whether transmission of the diagnostic information is acceptable, based on a comparison result between the request signal, identification information of the at least one external device, and a mapping table stored in a memory; and
transmitting, by the control device, the diagnostic information to the at least one external device in response to determining that transmission of the diagnostic information is acceptable.

10. The vehicle control method of claim 9, wherein the mapping table includes:
DID corresponding to pieces of data including the diagnostic information;
whether to allow a full client read for each of the pieces of data; and
an allowed source address capable of transmitting the diagnostic information if the full client read is not allowed.

11. The vehicle control method of claim 9, further comprising:
determining, by the control device based on comparing DID included in the request signal with the mapping table, whether the diagnostic information is information capable of allowing a full client read, by the control device; and
determining, by the control device by the control device, that transmission of th diagnostic information is acceptable, and transmitting the diagnostic information to the at least one external device, in response to determining that the diagnostic information is information capable of allowing the full client read.

12. The vehicle control method of claim 9, further comprising:
determining, by the control device based on comparing DID included in the request signal with the mapping table, whether the diagnostic information is information capable of allowing a full client read; and
identifying, by the control device based on at least part of pieces of information included in the request signal, the identification information of the at least one external device by the control device in response to determining that the diagnostic information is information incapable of allowing the full client read.

13. The vehicle control method of claim 9, further comprising:
determining, by the control device based on comparing DID included in the request signal with the mapping table, whether the diagnostic information is information capable of allowing a full client read; and
determining, by the control device based on the mapping table, whether the identification information of the at least one external device is included in an allowed source address, in response to determining that the diagnostic information is information incapable of allowing the full client read; and
determining, by the control device, that transmission of the diagnostic information is acceptable, and transmitting the diagnostic information to the at least one external device, in response to determining that the identification information is included in the allowed source address.

14. The vehicle control method of claim 9, further comprising:
determining, by the control device based on comparing DID included in the request signal with the mapping table, whether the diagnostic information is information capable of allowing a full client read;
determining, by the control device based on the mapping table, whether the identification information of the at least one external device is included in an allowed source address, in response to determining that the diagnostic information is information incapable of allowing the full client read; and
determining, by the control device, that transmission of the diagnostic information is not acceptable, and not transmitting the diagnostic information, in response to determining that the identification information is not included in the allowed source address.

15. The vehicle control method of claim 14, further comprising determining, by the control device, that transmission of the diagnostic information is not acceptable, and transmitting an NRC to the at least one external device, in response to determining that the identification information is not included in the allowed source address.

16. A computer-readable recording medium including a program for performing vehicle control operations, wherein the vehicle control operations comprise:
receiving a request signal regarding diagnostic information of a host vehicle from at least one external device by a control device;
determining whether transmission of the diagnostic information is acceptable, based on a comparison result between the request signal, identification information of the at least one external device, and a mapping table stored in a memory; and
transmitting the diagnostic information to the at least one external device in response to determining that transmission of the diagnostic information is acceptable.

17. The computer-readable recording medium of claim 16, wherein the mapping table includes:
DID corresponding to pieces of data including the diagnostic information;
whether to allow a full client read for each of the pieces of data; and
an allowed source address capable of transmitting the diagnostic information the full client read is not allowed.

18. The computer-readable recording medium of claim 16, wherein the vehicle control operations further comprise:
determining, based on comparing DID included in the request signal with the mapping table, whether the diagnostic information is information capable of allowing a full client read; and
determining that transmission of the diagnostic information is acceptable, and transmitting the diagnostic information to the at least one external device, in response to determining that the diagnostic information is information capable of allowing the full client read.

19. The computer-readable recording medium of claim 16, wherein the vehicle control operations further comprise:
determining, based on comparing DID included in the request signal with the mapping table, whether the diagnostic information is information capable of allowing a full client read; and
identifying, based on at least part of pieces of information included in the request signal, the identification information of the at least one external device by the control device in response to determining that the diagnostic information is information incapable of allowing the full client read.

20. The computer-readable recording medium of claim 16, wherein the vehicle control operations further comprise:
determining, based on comparing DID included in the request signal with the mapping table, whether the diagnostic information is information capable of allowing a full client read;
determining, based on the mapping table, whether the identification information of the at least one external device is included in an allowed source address, response to determining that the diagnostic information is information incapable of allowing the full client read; and
determining that transmission of the diagnostic information is acceptable, and transmitting the diagnostic information to the at least one external device, in response to determining that the identification information is included in the allowed source address.
